(19) United States
(12) Patent Application Publication
(10) Pub. No.: US 2026/0078983 A1
(43) Pub. Date: Mar. 19, 2026

(54) DEVICE FOR DETERMINING AN ANGULAR DEVIATION, VEHICLE, AND METHOD FOR DETERMINING AN ANGULAR DEVIATION

(71) Applicant: Rheinmetall Electronics GmbH, Bremen (DE)

(72) Inventor: Robert CLAESER, Bremen (DE)

(21) Appl. No.: 19/109,982

(22) PCT Filed: Sep. 7, 2023
(86) PCT No.: PCT/EP2023/074571

§ 371 Date: Mar. 7, 2025

(30) Foreign Application Priority Data
Sep. 8, 2022 (DE) 10 2022 122 842.8

(51) Int. Cl. F41G 3/32; F41G 3/14; F41G 5/24; G01S 17/06

(52) U.S. Cl. CPC F41G 3/323; F41G 3/142; F41G 5/24; G01S 17/06

(57) ABSTRACT

A device for determining an angular deviation between a line of sight and a line of fire of a gun is proposed. The device comprises: at least one clocked light source for generating at least one coherent light beam and for emitting the at least one generated coherent light beam, at least one neuromorphic camera for receiving at least the at least one emitted coherent light beam and for providing detection data at least from the received light beam, and a computing unit for determining the angular deviation by means of a correction value indicative of the angular deviation, wherein the computing unit is configured to determine the correction value as a function of at least one specific base calibration value and the provided detection data.

The present invention relates to a device for determining an angular deviation and to a vehicle. The present invention further relates to a method and a computer program product for determining an angular deviation.

Various weather conditions and thermal stresses in the field lead to deviations between the line of sight and the line of fire of the gun when firing projectiles by means of a gun, in turn influencing the firing accuracy, particularly at great distances.

In order to correct for said deviations, field adjustment systems are conventionally used. Static and dynamic field adjustment systems are known from the prior art.

The article T. Dursun et al: A review on the gun barrel vibrations and control for a main battle tank (Defence Technology 13 (2017)) discloses a static field adjustment system using collimators and a mirror mounted on the muzzle of the gun. Therein, a light pattern is displayed twofold in the visual display unit of a gunner: in the direct path and after reflection at the mirror. If the mirror has an alignment deviating from the straight-ahead calibration, that is, if the muzzle of the gun also does not point precisely straight ahead, then the light patterns in the visual image of the gunner do not match. The deviation from a reference position is then determined manually by the gunner and is fed into the fire control computer as a correction value. Static systems, however, cannot be used while in motion and are of only very limited use between shots, because said system requires manual measuring times and value entry.

The publications U.S. Pat. Nos. 5,513,000A and 7,124,676B1 each disclose dynamic field adjustment systems. Said dynamic field adjustment systems use detectors to be able to directly spatially associate the offset of arising signals reflected by the mirror of the muzzle and subsequently convert the same into an angular deviation.

Against this backdrop, an object of the present invention is to provide means for improving a field adjustment of a gun.

According to a first aspect, a device is proposed for determining an angular deviation between a line of sight and a line of fire of a gun. The device comprises:
at least one clocked light source for generating at least one coherent light beam and for emitting the at least one generated coherent light beam,
   at least one neuromorphic camera for receiving at least the at
   least one emitted coherent light beam and for providing detection
   data at least from the received light beam, and
a computing unit for determining the angular deviation by means of a correction value indicative of the angular deviation, wherein the computing unit is configured to determine the correction value as a function of at least one specific base calibration value and the provided detection data.

The proposed device forms a fully automated field adjustment system for determining the angular deviation between a line of sight of a gun and a line of fire of the gun by means of the combination of a clocked light source, neuromorphic camera, computing unit, a control unit of the device, and at least one actuator of the device for actuating the gun.

Said proposed device advantageously comprises increased accuracy and increased speed in determining the angular deviation, in turn leading to a correction of an angular deviation of a muzzle of the gun by means of the control unit and of the at least one actuator of the device actuated by the control unit being able to be performed more precisely and faster. As a result, the angular deviation between individual projectiles of the gun to be fired can be determined and a correction of the angular position of the muzzle of the gun can be made immediately after determining the angular deviation if necessary. The probability of the gun striking the target is thus increased, because the field adjustment system can continuously determine the angular deviation of the gun, in turn leading to increased efficiency when in combat with a target object.

The increased accuracy results from the use of the at least one clocked light source for emitting a plurality of coherent light beams in combination with the neuromorphic camera for receiving the plurality of coherent light beams, wherein the neuromorphic camera, as a detector of received coherent light beams, is constructed so as to have a high detection resolution and thereby provides the detection data at an increased resolution. The neuromorphic camera may be configured to determine, at the sub-pixel level, a center point and/or a pixel at the center point of a received light beam by means of suitable computing methods, such as interpolation or correlation. Determining the angular deviation at the sub pixel level is thereby made possible, leading to increased accuracy.

The increased speed results from the high clock frequency of the clocked light source when generating and emitting the plurality of coherent light beams and the high temporal resolution of the neuromorphic camera for detecting the emitted plurality of coherent light beams, as well as from the fully automated and continuous determining of the angular deviation by means of processing the data from the clocked light source, neuromorphic camera, and computing unit, wherein intervention by a human operator is not required. In other words, the increased speed results from the ability of the neuromorphic camera to quickly detect and process the plurality of coherent light beams emitted by the clocked light source at a high clock frequency, and from an electronic circuit of the clocked light source timed to match to the same.

The term “clocked” may be understood to mean that a coherent light beam is emitted not continuously, but rather in a pulsed manner, meaning that the coherent light beam is emitted in temporally limited pulses at a particular clock frequency. The clocked light source may be, preferably, a clocked laser source.

Furthermore, the term “coherent” may be, preferably, understood to mean that a plurality of emitted light beams each have a fixed phase relationship to each other at the same frequency.

A neuromorphic camera is implemented as an “event camera” or “silicone retina” or “dynamic vision sensor”. A neuromorphic camera is an image sensor that reacts to changes in the quantum flow (photon flow) of the light of pixels. A neuromorphic camera may be configured to detect, for example independently, a change in the quantum flow of each pixel in a detector matrix of the neuromorphic camera and to report the change only when said change is detected by the neuromorphic camera. A neuromorphic camera advantageously may have no detection deadtime when detecting received (coherent) light beams, because said camera has no electronic or mechanical closure time in comparison with conventional cameras and thus is able to detect received light beams at any time. Furthermore, the neuromorphic camera may be further advantageously implemented because said camera may have a low latency, for example 1 μs (microsecond), significantly reduced in comparison with conventional cameras, said cameras having a latency of above 16 ms (milliseconds) at image refresh rates of 60 hertz per second.

A line of sight (LOS) of the gun may correspond to the straight line between the point of firing or the muzzle of the gun and a target object present in the distance.

A line of fire (LOF) of the gun may correspond to the extension of the center axis of the barrel of the gun. The line of fire may be the alignment at which the gun is aligned prior to firing.

The clocked light source, the neuromorphic camera, and the computing unit may be connected to each other by wires and/or wirelessly, so that said devices are able to transfer electrical signals and exchange data among each other. Furthermore, the device may also comprise more than one clocked light source for generating at least one coherent light beam and for emitting the at least one generated coherent light beam. Furthermore, the at least one clocked light source may be configured to generate the at least one coherent light beam and to emit the same in the direction of the neuromorphic camera.

“Indicative of the correction value” may mean that the angular deviation or at least a value or an angle of the angular deviation can be derived or calculated using the particular correction value.

The corresponding unit, for example the computing unit, may be implemented as hardware and/or as software as well. For a hardware implementation, the corresponding unit may be implemented as a device or as part of a device, for example as a computer, as an FPGA (Field Programmable Gate Array), or as a microprocessor. For a software implementation, the corresponding unit may be implemented as a computer program product, as a function, as a routine, as part of a program code, or as an executable object.

According to one embodiment, the at least one clocked light source is implemented as a surface emitter.

The term “surface emitter” is understood to mean the term “Vertical Cavity Surface Emitting Laser (VCSEL)”. A VCSEL is particularly a laser source for emitting the light perpendicular to the surface thereof at a high beam quality and low power.

The VCSEL may be disposed in a module. The module may comprise optics disposed in the optical path of the VCSEL.

The VCSEL may advantageously have a size of 1 mm² (square millimeter) and a low weight. The total weight of the device is thus reduced.

According to a further embodiment, the at least one clocked light source is configured to generate the at least one coherent light beam having a wavelength in the near-infrared range, particularly having a wavelength of 880 nm, 940 nm, or 1550 nm.

The neuromorphic camera is further configured to receive and to detect the at least one coherent light beam at least having a wavelength included in the wavelength range of ultraviolet light (UV light), light visible to the human eye, and the NIR (near-infrared range). To this end, the neuromorphic camera may comprise at least one detector chip. The detector chip is implemented, for example, by means of silicon, quantum points, and/or indium gallium arsenide (InGaAs). The range of UV light may extend from 100 nm (nanometers) to 380 nm, the range of light visible to the human eye from 380 nm to 780 nm, and the near infrared range over a wavelength range from 780 nm to 3000 nm. The neuromorphic camera is thus also configured to receive the at least one coherent light beam having a wavelength in a SWIR (short-wave infrared range), being part of the NIR having a wavelength range from 780 nm to 1400 nm. Furthermore, the at least one clocked light beam is configured to generate the at least one coherent light beam at least having a wavelength in the wavelength range of UV light and/or in the range of light visible to the human eye.

According to a further embodiment, the device is further characterized by:
the gun having a barrel, wherein the barrel comprises a muzzle.

According to a further embodiment, the at least one clocked light source is configured to generate a plurality of coherent light beams and to emit the same in a predetermined pattern.

Emitting the plurality of coherent light beams has the advantage that the probability is increased that at least one other emitted coherent light beam of the plurality is detected by the neuromorphic camera, even when a large angular deviation leads to one of the emitted coherent light beams no longer entering the neuromorphic camera, for example after being reflected at a mirror of the device. This may advantageously increase the reliability when determining the angular deviation of the device.

The at least one clocked light source may be configured to generate a plurality of coherent light beams and to emit the same in a predetermined pattern, for example in the direction of the at least one neuromorphic camera or in the direction of the mirror.

Furthermore, the neuromorphic camera is configured to detect the emitted plurality of coherent light beams at the sub-pixel level, for example after being reflected at the mirror, or when directly receiving the emitted plurality. The center point and/or a pixel at the center point of at least one received light beam can be determined by means of suitable computing methods, such as interpolation or correlation, with an accuracy at the sub-pixel level, for example when the predetermined pattern of the received light beams is known. This may advantageously increase the spatial resolution when providing or when generating detection data, in turn leading to increased accuracy when detecting emitted coherent light beams. The receiving and precise detecting of the plurality of light beams by means of the neuromorphic camera in the neuromorphic camera may advantageously lead to an increase in the measurement accuracy of the device.

In comparison with conventional devices having non-clocked light sources, such as broadband light sources, for example light bulbs, an additional further advantage may be that the device is difficult for an enemy entity to discover. This is the case because the VCSEL emits the coherent light beams thereof, for example in short pulses, for example greater than or equal to 1 kHz, at a specific wavelength having a low bandwidth. Due to the short pulses having a low duty cycle in clocked operation, the waste heat and thus the thermal signature of the device may advantageously be kept low. Thus the probability of detection of the at least one of the light beams emitted by the at least one clocked light source by enemy entities is reduced, because the clocking of the clocked light source is not known to the same.

According to a further embodiment, the predetermined pattern has a temporal pattern and/or a spatial pattern, wherein the at least one clocked light source is configured to emit the plurality of coherent light beams as a temporal pattern at a predetermined clock frequency and/or is configured to emit the plurality of coherent light beams in the form of a light pattern comprising the plurality of coherent light beams.

A clock frequency comprises the quantity of cycles performed per second by the clocked light source. For example, the clocked light source is operated at a predetermined clock frequency of greater than or equal to 1 kHz (kilohertz). A high temporal resolution may correspond to emitting the plurality of coherent light beams at the predetermined clock frequency by the clocked light source. A high temporal resolution may further correspond to receiving and/or processing the plurality of coherent light beams by the neuromorphic camera at the predetermined clock frequency.

A light pattern may be a specific spatial arrangement of the plurality of coherent light beams, wherein the corresponding coherent light beams are emitted at a particular spacing from each other, resulting in a light pattern of coherent light beams.

The at least one clocked light source may be configured to emit the plurality of coherent light beams as a temporal pattern at a predetermined clock frequency, for example in the direction of the at least one neuromorphic camera or in the direction of the mirror, and/or is configured to emit the plurality of coherent light beams as a spatial pattern in the form of a light pattern comprising the plurality of coherent light beams, for example in the direction of the at least one neuromorphic camera or in the direction of the mirror.

According to a further embodiment, the at least one clocked light source comprises a first mode in which the at least one clocked light source is configured to generate and to emit the coherent light beam, and a second mode in which the at least one clocked light source is configured to generate the plurality of coherent light beams and to emit the same in the predetermined pattern, wherein the at least one clocked light source comprises a toggle unit configured to switch between the first and the second mode.

Said embodiment has the advantage that it is possible, by means of the toggle unit, to switch to the first or the second mode depending on the dynamic motion or camouflage requirements, for example when the device is mounted on a vehicle or a trailer.

In the case of highly dynamic motion of the device, for example, there is a greater probability that the coherent light beams will miss the mirror or the neuromorphic camera and thus can be more easily detected by opposing (enemy) entities (units). If, in a preferred example, only one single, centrally aligned coherent light beam is first emitted in the first mode, for example in the direction of the at least one neuromorphic camera or in the direction of the mirror, then the angular deviation may be captured at reduced accuracy in a first step. In a second step, a fine correction may take place after successful correction at reduced accuracy, after the plurality of coherent light beams emitted in the second mode has arrived at the mirror and then at the detector matrix of the neuromorphic camera, or directly at the detector matrix of the neuromorphic camera. This increases the accuracy and thus the reliability of the device when determining the angular deviation.

In the case of increased camouflage requirements for the device, said embodiment enables first emitting only one coherent light beams in the first mode in the direction of the mirror or the neuromorphic camera, for example even for a severe field adjustment, not yet captured and corrected, by means of said only one coherent light beam, and then performing a fine correction in the second mode by means of the emitted plurality of coherent light beams.

In particularly dynamic scenarios, wherein the camouflage of the position of the device no longer plays a role, a plurality of coherent light beams may be emitted directly in the second mode for an expected greater angular deviation. The expected greater angular deviation thereby may require a wider distribution of the emitted coherent light beams due to the highly dynamic motion of the vehicle and/or of the gun.

According to a further embodiment, the device is further characterized by:
a control unit configured to actuate at least one actuator of the gun for correcting the alignment of the gun in the azimuth and/or elevation as a function of the particular correction value.

The control unit may be connected at least to the clocked light source, the neuromorphic camera, and the computing unit for transferring data and/or electrical signals.

The control unit may be configured to actuate one or more actuators of the gun for correcting the alignment of the gun in the azimuth and/or elevation as a function of a specific absolute value of the correction value.

According to a further embodiment, the control unit is implemented as a fire control computer, wherein the fire control computer is configured to actuate the gun such that the gun fires a projectile or a plurality of projectiles.

An actuator may be implemented as a motor for displacing and/or adjusting the gun in the azimuth and/or elevation. The motor may be actuated by the fire control computer.

According to a further embodiment, the at least one neuromorphic camera is further configured to track a flight path of the projectile fired by the gun for obtaining current calibration data, wherein the computing unit is configured to update the at least one specific base calibration value at least as a function of the current calibration data.

According to a further embodiment, the at least one neuromorphic camera is further configured to track a corresponding flight path of a corresponding projectile fired by the gun from the plurality of projectiles fired by the gun for obtaining corresponding current calibration data, wherein the computing unit is configured to update the at least one specific base calibration value as a function of the corresponding calibration data obtained after each projectile fired by the gun.

In so doing, the neuromorphic camera fulfills a plurality of tasks as a detector:
On one hand, the neuromorphic camera is further configured to provide detection data on the basis of received coherent light beams prior to firing a projectile and to provide the same to the computing unit, so that the computing unit is configured to determine the correction value prior to, during, and/or after the firing of a projectile by the gun.

In addition, the neuromorphic camera is configured, due to the high temporal and spatial resolution thereof, to track the flight path of the projectile fired by the gun or a corresponding flight path of a corresponding projectile fired by the gun of the plurality of projectiles fired by the gun, to obtain current calibration data. Furthermore, the neuromorphic camera is configured as a detector to detect objects, such as drones, implemented as target objects.

The tracking may comprise determining an impact point of the fired projectile in or near a target object, for example an enemy tank, an enemy watercraft, or an enemy aircraft. In addition, the neuromorphic camera may then be configured to evaluate the impact point with respect to determining a probability of a hit. The neuromorphic camera is thereby further configured as a detector to also capture the time of impact of the projectile and consequences of the impact or a miss of the target object.

This has the advantage that vibrations of the gun arising when the device is in motion, particularly when said device is disposed on a vehicle or a trailer, and/or vibrations of the gun arising due to firing or motion of the gun are captured and changes in the surrounding area occurring between the projectiles to be fired are taken into consideration when determining the angular deviation by tracking the flight path.

After each fired projectile, changes in the surrounding area, such as a change in wind direction or velocity, may be used as current calibration data. Said current calibration data may then be used for updating the specific base calibration value, for example for updating a reference position of the specific base calibration value. Thus, the specific base calibration value may be determined anew based on the current, updated calibration data prior to firing a further projectile. This increases the accuracy when determining the angular deviation in the field. Thus, the accuracy when firing a sequence of projectiles by means of the gun may additionally advantageously be increased.

According to a further embodiment, the at least one specific base calibration value comprises at least one reference position indicative of a particular reference angular position of the muzzle of the barrel of the gun, and the provided detection data comprise at least one particular entry position in the neuromorphic camera of the light beam received by the at least one neuromorphic camera, wherein the particular entry position is indicative for a particular angular position of the muzzle of the barrel of the gun, wherein the computing unit is configured to determine the correction valve by applying a mathematical operation to the at least one reference position and the particular entry position.

The relationships between the terms angular deviation, reference position, provided detection data, particular entry position, and particular correction value are explained below.

The computing unit is configured to determine the angular deviation between the line of sight and the line of fire of the gun. To this end, the computing unit may be configured to determine the angle or the angular position of the muzzle of the barrel of the gun before and after each fired projectile from the gun or when a projectile exits the gun. The particular angular position of the muzzle may comprise an azimuth angle and an elevation angle.

“Indicative of the particular reference angular position” may mean that the particular reference angular position of the muzzle of the barrel of the gun can be derived or calculated using the reference position. The particular reference angular position may indicate the azimuth and elevation of an angular position of the muzzle of the barrel of the gun at which the angular deviation between the LOS and LOF of the gun is zero.

The particular reference angular position may be implemented once, statically, by means of fixed, specified values, or may be able to be updated dynamically using current calibration data. The computing unit may be configured to update the particular reference angular position of the specific base calibration value as a function of current calibration data. The particular reference angular position comprises further values and calibration data able either to be incorporated in determining the correction value by the particular reference angular position or integrated directly in the mathematical operation as further parameters when determining the correction value, for example: distance to the target object, air temperature and air pressure, type of ammunition and powder temperature (ballistic data), wind conditions, curvature of the earth, gravity, general system errors, integral vehicle velocity, tilting when the projectile exits, estimated target velocity, relative humidity, and/or the Coriolis effect.

The neuromorphic camera may be configured to transfer the provided detection data at least to the computing unit. Providing the detection data of the neuromorphic camera may comprise generating the detection data at least from the received light beam or from the light beam reflected by the mirror and received (received reflected light beam).

“Indicative of the particular angular position of the muzzle” may means that the particular angular position of the muzzle of the barrel of the gun at a particular point in time can be derived or calculated using the particular entry position of the received or received reflected light beam. The particular point in time may comprise a point in time before, during, and/or after firing a projectile from the gun. The particular entry position may be such a position at which a coherent light beam received by the neuromorphic camera enters in the neuromorphic camera in the detector matrix of the neuromorphic camera, or a coherent light beam reflected by the mirror and received by the neuromorphic camera enters in the detector matrix of the neuromorphic camera. From said particular entry position, together with the reference position, an offset or a correction value between said two positions can be determined by applying a mathematical operation. Using the correction value indicating a deviation between the angular position of the muzzle of the barrel of the gun and the particular reference angular position, the particular angular deviation can be corrected.

A mathematical operation may comprise subtracting the particular entry position from the reference position for determining the correction value. The mathematical operation may also comprise a correlation method, by means of which at least one correlation across the plurality of received light beams is calculated for determining the correction value. The quantity of the received light beams may also be determined by means of the mathematical operation.

If the result of said subtraction of the correction value is zero, for example, then no angular deviation particularly exists between the line of sight and the line of fire of the gun. If the correction value as the result of said subtraction is not equal to zero, however, then an angular deviation preferably exists. The magnitude of said particular angular deviation or the value of the angular deviation is indicated by the correction value.

The particular correction value may be entered into the control unit as an input parameter, after which the control unit is then configured to correct the angular deviation between the LOS and LOF of the gun using the entered correction value. In other words, the control unit is configured to correct the angle of the muzzle of the gun by said particular correction value, so that for a subsequent firing of a projectile by means of the gun, said gun is again correctly calibrated and adjusted, and may have an angular deviation of zero.

For example, the above values and calibration data are saved in advance in the computing unit or in a memory of the device connected to the computing unit. Preferably, for a particular range, that is, a distance from the device or the muzzle of the gun to a target object, a particular reference angular position comprising particular values and calibration data is saved in the memory or the computing unit.

According to a further embodiment, the at least one neuromorphic camera comprises an optical aperture and a detector matrix implemented in an optical path of the neuromorphic camera, wherein the at least one neuromorphic camera is configured to receive the at least one emitted light beam through the optical path onto the detector matrix, wherein the optical aperture comprises an aspherical lens implemented, for example, as a metalens or by means of a plurality of DOE (Digital Optical Elements).

According to a further embodiment, the device is further characterized by:
a mirror disposed at the muzzle of the barrel of the gun, wherein the at least one clocked light source is configured to emit the generated coherent light beam in the direction of the mirror and the at least one neuromorphic camera is configured to receive at least the light beam reflected by the mirror and is further configured to provide detection data at least from the received reflected light beam.

The muzzle is the point of exit of the projectile of the gun. The mirror may be disposed at a right or left side of an outer surface of the barrel at the muzzle. The mirror may be disposed at a top side of an outer surface of the barrel at the muzzle. Said arrangement of the mirror at the muzzle and the distance to the neuromorphic camera allow reliable reflecting of emitted coherent light beams to the neuromorphic camera.

The mirror has reflective properties, so that the at least one coherent light beam emitted by the clocked light source is reflected by the mirror, particularly according to the law of reflection, and is returned to the neuromorphic camera by the mirror as a reflected light beam.

According to a further embodiment, the at least one specific base calibration value comprises at least one reference position indicative of a particular reference angular position of the muzzle of the barrel of the gun, and the provided detection data comprise at least one particular entry position in the neuromorphic camera of the light beam reflected by the mirror and received by the at least one neuromorphic camera, wherein the particular entry position is indicative for a particular angular position of the muzzle of the barrel of the gun, wherein the computing unit is configured to determine the correction valve by applying a mathematical operation to the at least one reference position and the particular entry position.

According to a further embodiment, the at least one clocked light source and the at least one neuromorphic camera are each disposed at one end of the barrel of the gun opposite the muzzle of the barrel of the gun.

The end of the barrel of the gun may be connected to a base of a permanently installed, immobile weapon system or of a vehicle potentially comprising the device. If the vehicle is implemented as a battle tank, then the base is implemented, for example, as a tank turret.

According to a further embodiment, the at least one clocked light source is implemented at the end of the barrel of the gun and the at least one neuromorphic camera is disposed at the muzzle of the barrel of the gun.

The at least one clocked light source and the neuromorphic camera are thus disposed opposite each other at different ends of the barrel of the gun. The at least one clocked light source may thus be configured to generate the at least one coherent light beam and to emit the same in the direction of the neuromorphic camera at the muzzle of the barrel.

According to a further embodiment, the at least one clocked light source and/or the neuromorphic camera are disposed in an optical channel, particularly in a periscope, of a gunner for the gun, or at the base of the vehicle on an outer surface of the vehicle.

The gunner may be the operator of the vehicle, for example the operator of a control unit for controlling the gun of the vehicle.

According to a further embodiment, the at least one neuromorphic camera comprises an optical aperture and a detector matrix implemented in an optical path of the neuromorphic camera, wherein the at least one neuromorphic camera is configured to receive the at least one light beam reflected by the mirror through the optical path onto the detector matrix, wherein the optical aperture comprises an aspherical lens implemented, for example, as a metalens or by means of a plurality of DOE (Digital Optical Elements).

The neuromorphic camera may comprise a detector matrix for detecting or receiving emitted coherent light beams. The neuromorphic camera may comprise an optical aperture implemented in the optical path from the neuromorphic camera implemented as an imaging sensor and through which the received and/or reflected coherent light beams impinge on the detector matrix. The neuromorphic camera may be disposed in a first housing, while the clocked light source is disposed in a second housing. The at least one neuromorphic camera and the at least one clocked light source may also be disposed in a common housing, for example when the at least one neuromorphic camera and the at least one clocked light source are disposed at the end of the barrel of the gun opposite the muzzle of the gun.

An aspherical lens may be a lens having at least one refracting surface deviating from a spherical or planar shape. The advantage of an aspherical is preferably the freely shapable surface, by means of which imaging errors can be reduced, said errors being present in contrast thereto for spherical lenses. By using the aspherical lens in the neuromorphic camera, the distance of the plurality of coherent light beams received by the neuromorphic camera at the detector matrix of the neuromorphic camera may vary, and said variation may be taken into consideration by computational measures. By means of said aspherical lens in the neuromorphic camera, high spatial resolutions may advantageously be generated for a narrow field of vision in the center of the detector matrix, and larger fields of vision having lower spatial resolution may be generated in peripheral fields of view at the edge of the detector matrix.

In a particularly advantageous embodiment, the aspherical lens is implemented as a metalens or by means of a plurality of DOE (Digital Optical Elements), enabling an individual adjustment of the field of view (FOV) resolution in order to generate an aspherical field of view having higher spatial resolution at the center of the detection matrix and a large FOV having lower resolution at the edges of the detector matrix, as previously described in the above paragraph.

According to a further embodiment, the device is further characterized by:
a plurality of neuromorphic cameras, wherein each neuromorphic camera of the plurality is configured to receive at least the emitted light beam.

The present embodiment has the advantage that the probability is increased that at least one emitted coherent light beam is able to be received and detected by at least one neuromorphic camera of the plurality of neuromorphic cameras, even when a larger angular deviation is present. This advantageously increases the reliability of the device.

In one embodiment, an arrangement of at least two neuromorphic cameras and one clocked light source may be implemented at the end of the barrel of the gun opposite the muzzle of the gun. For example, the clocked light source is thus disposed in the center and one neuromorphic camera each is disposed to the left and right thereof, of which at least one of the two neuromorphic cameras is configured to receive the at least one reflected coherent light beam. In an embodiment, at least one clocked light source may also be implemented at the end of the barrel of the gun opposite the muzzle of the gun, and an arrangement of at least two neuromorphic cameras may be implemented opposite thereto at the muzzle of the gun.

Each neuromorphic camera of the plurality may be configured to receive at least the light beam reflected by the mirror.

According to a second aspect, a vehicle is proposed, for example a military or a civilian vehicle, having a device according to the first aspect or an embodiment of the first aspect.

According to a further embodiment, the vehicle according to the second aspect is implemented as an unarmored vehicle, as an armored vehicle, for example as a tracked vehicle such as a battle tank or a wheeled tank, as a watercraft, for example as a warship, and/or as an amphibious vehicle, particularly as a military or civilian amphibious vehicle.

The device may be disposed on the vehicle or on a trailer. The vehicle may also comprise a vehicle having a trailer. Both the vehicle and the trailer may be used in the military or civilian fields. The trailer may comprise a carriage in which the device, particularly the barrel of the gun, is supported. For example, the vehicle is further implemented as a police vehicle or a ship of a coast guard. The vehicle may thus be implemented as a patrol boat, for example as a patrol boat of the Navy, the Coast Guard, the police, or the customs office.

The device may also be part of a permanently installed, particularly immobile, weapon system. A permanently installed weapon system is implemented, for example, as a defensive system, for example a military defensive system potentially comprising at least one device having the gun. The permanently installed weapon system may also comprise a plurality of devices each disposed at different positions or locations within the permanently installed weapon system.

A gun is implemented as an artillery piece, for example as a cannon of a battle tank, as a permanently installed gun of the weapon system, or as a naval artillery piece. The gun may have a caliber of at least 20 millimeters.

For example, a command center of the vehicle comprises the fire control computer by means of which the gun can be operated or remotely operated.

According to a third aspect, a method is proposed for determining an angular deviation between a line of sight and a line of fire of a gun. The method comprises the steps of:
a) generating at least one coherent light beam by means of a clocked light source and emitting the at least one generated coherent light beam,
b) receiving at least the at least one emitted coherent light beam by means of at least one neuromorphic camera and providing detection data at least from the received light beam, and
c) determining the angular deviation by means of a correction value indicative of the angular deviation, wherein the correction value is determined as a function of at least one specific base calibration value and the provided detection data.

The embodiments and features described for the proposed device according to the first aspect apply correspondingly to the proposed method according to the third aspect.

According to a fourth aspect, a computer program product is proposed, comprising commands causing a computer to perform the method according to the third aspect when the program is executed by said computer.

A computer program product, such as a computer program means, may be provided or delivered as a memory medium, such as a memory card, USB stick, CD-ROM, DVD, or in the form of a downloadable file from a server in a network, for example. This may take place, for example, in a wireless communications network by transferring a corresponding file having the computer program product or the computer program means.

Further potential implementations of the invention also comprise not explicitly mentioned combinations of features or embodiments described above or below with respect to the embodiment examples. The person skilled in the art will also add individual considerations as improvements or additions to the basic form of the invention.

Further advantageous embodiments and considerations of the invention are the subject matter of the subclaims and of the embodiment examples of the invention described below. The invention is described below in greater detail using exemplary embodiments, with reference to the attached figures.

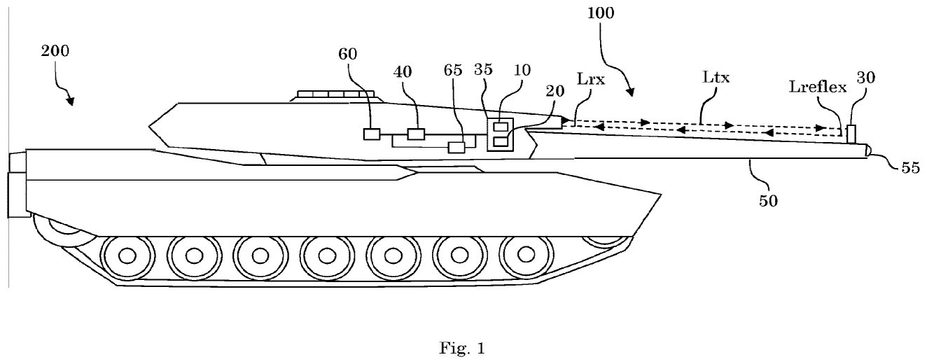

FIG. 1 shows a schematic block diagram of an embodiment example of a device for determining an angular deviation;

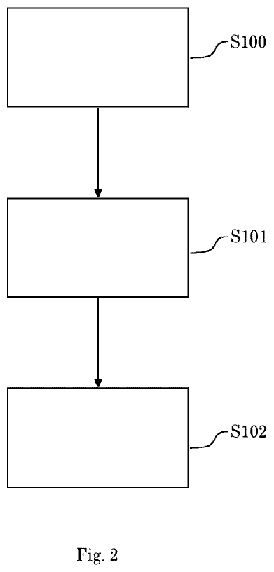

FIG. 2 shows a schematic flow diagram of an embodiment example of a method for determining an angular deviation; and

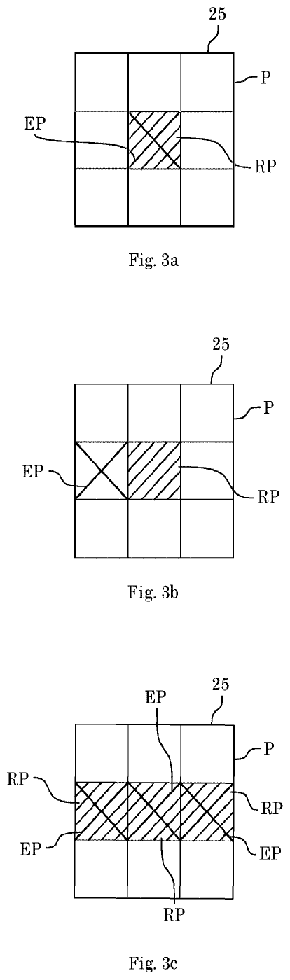

FIG. 3a to 3c each schematically show a detector matrix of a neuromorphic camera in different embodiment examples.

In the figures, identical or functionally identical elements are labeled with the same reference numeral unless otherwise indicated.

FIG. 1 shows a schematic block diagram of an embodiment example of a device 100 for determining an angular deviation between a line of sight and a line of fire of a gun 50. In the embodiment of FIG. 1, the device 100 is part of a vehicle 200. In other embodiments, the device 100 is not part of a vehicle 200 (not shown). For example, the device 100, particularly the gun 50, may be permanently installed in an immobile weapon system. In FIG. 1, the vehicle 200 is implemented as a battle tank. In embodiments, the vehicle 200 may be implemented as a watercraft, particularly as a warship, or as an amphibious vehicle.

In addition, references to the method steps S100 to S102 from FIG. 2, which shows a schematic flow diagram of an embodiment example of a method for determining an angular deviation, are also provided in brackets in the following explanations of FIG. 1.

The device 100 in FIG. 1 comprises at least one clocked light source 10, a neuromorphic camera 20, a mirror 30, a computing unit 40, a gun 50, and a control unit 60. The at least one clocked light source 10 and the neuromorphic camera 20 in FIG. 1 are disposed in a common housing 35. Furthermore, the housing 35, the computing unit 40, the control unit 60, and an actuator 65 in FIG. 1 are physically connected to each other for transferring data. The actuator 65 is connected to the gun 50. The device 100 may also be implemented without the mirror 30 (not shown). In this case, the clocked light source 10 emits at least one generated coherent light beam Ltx in the direction of the neuromorphic camera 20, wherein in this case the clocked light source 10 is disposed on a base of the vehicle 200, for example, and the neuromorphic camera 20 is disposed at the muzzle 55 of the barrel of the gun 50 instead of the mirror 30. The clocked light source 10 and the neuromorphic camera 20 are thus disposed opposite each other (not shown).

In FIG. 1, the at least one clocked light source 10 is configured to generate at least one coherent light beam Ltx having a wavelength in the near-infrared range, for example having a wavelength of 880 nm (nanometers), and to emit the generated coherent light beam Ltx, for example in the direction of the mirror 30 (see step S100 of FIG. 2). Said generating and emitting of the at least one coherent light beam Ltx is referred to as a first mode of the clocked light source 10. In FIG. 1, the at least one clocked light source 10 is implemented as a surface emitter. The mirror 30 is disposed at a muzzle 55 of the barrel of the gun 50.

The neuromorphic camera 20 is configured to receive at least the emitted light beam Ltx or the light beam Lreflex reflected by the mirror 30 and to provide detection data at least from the received and/or reflected light beam Lrx, Lreflex (see step S101 of FIG. 2). In embodiments, the device 100 comprises a plurality (not shown) of neuromorphic cameras 20. Each neuromorphic camera 20 of the plurality is thus configured to receive at least the emitted light beam Ltx. Furthermore, at least one of the neuromorphic cameras 20 of the plurality comprises an optical aperture (not shown) and a detector matrix 25 (see FIG. 3) implemented in an optical path of the neuromorphic camera 20. The at least one neuromorphic camera 20 is configured to receive the at least one emitted light beam Ltx or the at least one light beam Lreflex reflected by the mirror 30 through the optical path at the detector matrix 25. In one embodiment, the optical aperture is an aspherical lens implemented, for example, as a metalens or by means of a plurality of DOE (Digital Optical Elements).

In FIG. 1, the clocked light source 10 and the neuromorphic camera 20 are each disposed at one end of the barrel of the gun 50 opposite the muzzle 55 of the barrel of the gun 50. This corresponds to an embodiment example of the device 100 if said embodiment comprises the mirror 30.

The computing unit 30 is then configured to determine the angular deviation by means of a correction value indicative of the angular deviation. The computing unit 40 is thus configured to determine the correction value as a function of at least one specific base calibration value and the provided detection data (see step S102 in FIG. 2).

Furthermore, the clocked light source 10 of FIG. 1 is also configured to generate a plurality of coherent light beams Ltx and to emit the same in a predetermined pattern in the direction of the mirror 30 or of the neuromorphic camera 20. Said generating and emitting of the plurality of coherent light beams Ltx is referred to as a second mode of the clocked light source 10. To this end, the at least one clocked light source 10 comprises a toggle unit (not shown) configured to switch between the first and the second mode. The predetermined pattern comprises a temporal pattern and a spatial pattern.

The control unit 60 of the device 100 in FIG. 1 is configured to actuate the at least one actuator 65 of the gun 50 for correcting the alignment of the gun 50 in the azimuth and/or elevation as a function of the particular correction value. In FIG. 1, the control unit 60 is implemented as a fire control computer. The fire control computer is configured to actuate the gun 50 such that the gun 50 fires a projectile or a plurality of projectiles.

Furthermore, the neuromorphic camera 20 of FIG. 1 comprises an additional function. Said additional function is further configured to track a flight path of the projectile fired by the gun 50 for obtaining current calibration data. In the course thereof, the computing unit 40 is configured to update the at least one specific base calibration value at least as a function of the current calibration data.

The neuromorphic camera 20 of FIG. 1 is further configured to track a corresponding flight path of a corresponding projectile fired by the gun 50 from the plurality of projectiles fired by the gun 50 so as to obtain corresponding current calibration data. The computing unit 40 is thus configured to update the at least one specific base calibration value as a function of the corresponding calibration data obtained after each projectile fired by the gun 50.

FIG. 2 shows a flow diagram depicting the steps of the method for determining an angular deviation according to one embodiment example. The method comprises the steps S100 to S102. The corresponding method steps S100 to S102 have already been explained using FIG. 1, for which reason the method steps S100 to S102 are not described again to avoid repetition.

FIG. 3a to 3c each schematically show an embodiment of the detector matrix 25 of a neuromorphic camera 20 (see FIG. 1). The detector matrix 25 is integrated into the neuromorphic camera 20, and the coherent light beams Lreflex (see FIG. 1) reflected by the mirror 30 (see FIG. 1), or the coherent light beams Ltx (see FIG. 1) emitted by the clocked light source 10 in the direction of the neuromorphic camera 20, impinge on the detector matrix 25.

The detector matrix 25 in the corresponding FIG. 3a through 3c comprises nine pixels P in each case. A detector matrix 25 may also comprise more or fewer than nine pixels P. The pixel P at the center of the detection matrix 25 is referred to as the reference position RP. The specific base calibration value comprises the reference position RP. The reference position RP is indicative of a particular reference angular position of the muzzle 55 (see FIG. 1) of the barrel of the gun 50 (see FIG. 1) In FIG. 3a, a particular entry position EP of the light beam Ltx received by the neuromorphic camera 20 or of the light beam Lreflex, Lrx reflected by the mirror 30 and received by the neuromorphic camera 20 is shown by a cross in the detector matrix 25 of the neuromorphic camera 20. The provided detection data comprise the at least one particular entry position EP. Furthermore, the particular entry position EP is indicative of a particular angular position of the muzzle 55 of the barrel of the gun 50.

In FIG. 3a, the particular entry position EP is present in the same pixel P of the detector matrix 25 as that pixel P in which the reference position RP is present. If the computing unit 40 (see FIG. 1) is configured to determine the correction value by applying a mathematical operation to the at least one reference position RP and the particular entry position EP, then in the case of FIG. 3a the resulting correction value is equal to zero. This is the case because the pixel P of the reference position RP and the pixel P of the particular entry position EP are superimposed. Thus, the light beam Lrx received in the detector matrix 25 has, as the entry position EP, the same pixel as such a pixel P determined in advance for the reference position RP. The reference position RP is particularly formed as a function of an emitted position and/or of an emitted angle of the coherent light beam Ltx (see FIG. 1) generated and emitted by the clocked light source (10) (see FIG. 1). The angular deviation in FIG. 3a thus has the value of zero.

In FIG. 3b, the cross of the particular entry position EP is disposed in a pixel P to the left of the pixel P of the reference position RP. If the computing unit 40 is subsequently configured to determine the correction value analogously to FIG. 3a, then in the case of FIG. 3b the resulting correction value is not equal to zero. There is thus an angular deviation. The control unit 60 (see FIG. 1) is thus configured to perform a correction of the alignment of the gun 50 by means of the actuator 65 (see FIG. 1) as a function of a magnitude of the correction value.

In FIG. 3c, three reference positions RP are shown. Three reference positions RP are thus depicted because the clocked light source 10 is configured to emit the plurality of coherent light beams Ltx as a spatial pattern, in the form of a light pattern comprising the plurality of coherent light beams Ltx, in the direction of the mirror 30 or in the direction of the at least one neuromorphic camera 20. Alternatively, the clocked light source 10 is configured to emit the plurality of coherent light beams Ltx as a temporal pattern, having a predetermined clock frequency, in the direction of the mirror 30 or in the direction of the at least one neuromorphic camera 20. FIG. 3c thus also comprises three particular entry positions EP associated with the corresponding three reflected coherent light beams Lreflex and impinging on the detector matrix 25. If an angular deviation were to be too great, then one of the three emitted coherent light beams Ltx cannot impinge on the detector matrix 25 (not shown). As can be seen in FIG. 3c, the three crosses (three pixels) of the particular entry positions EP are each superimposed on the three pixels of the three reference positions RP. If the computing unit 40 is configured to determine the correction value by applying a mathematical operation to the three reference positions RP and the particular entry position EP, then in the case of FIG. 3c the resulting correction value is equal to zero. There is thus no angular deviation.

Although the present invention has been described using embodiment examples, the invention can be variously modified.

### REFERENCE CHARACTER LIST

10 clocked light source
20 neuromorphic camera
25 detector matrix
30 mirror
35 housing
40 computing unit
50 gun
55 muzzle
60 control unit
65 actuator
100 device
200 vehicle
EP entry position
Ltx emitted light beam
Lreflex reflected light beam
Lrx received light beam
P pixel
RP reference position
S100 method step
S101 method step
S102 method step

1. A device for determining an angular deviation between a line of sight and a line of fire of a gun, comprising:
at least one clocked light source for generating at least one coherent light beam and for emitting the at least one generated coherent light beam,
at least one neuromorphic camera for receiving at least the at least one emitted coherent light beam and for providing detection data at least from the received light beam, and
a computing unit for determining the angular deviation using a correction value indicative of the angular deviation, wherein the computing unit is configured to determine the correction value as a function of at least one specific base calibration value and the provided detection data.

2. The device according to claim 1,
characterized in that
the at least one clocked light source is implemented as a surface emitter.

3. The device according to claim 1,
characterized in that
the at least one clocked light source is configured to generate the at least one coherent light beam having a wavelength in the near-infrared range, particularly having a wavelength of 880 nm, 940 nm, or 1550 nm.

4. The device according to claim 1, further characterized by:
the gun having a barrel, wherein the barrel comprises a muzzle.

5. The device according to claim
characterized in that
the at least one clocked light source is configured to generate a plurality of coherent light beams and to emit the same in a predetermined pattern.

6. The device according to claim 5,
characterized in that
the predetermined pattern comprises a temporal pattern and/or a spatial pattern, wherein the at least one clocked light source is configured to emit the plurality of coherent light beams as a temporal pattern at a predetermined clock frequency and/or is configured to emit the plurality of coherent light beams as a spatial pattern in the form of a light pattern comprising the plurality of coherent light beams.

7. The device according to claim 5,
characterized in that
the at least one clocked light source comprises a first mode in which the at least one clocked light source is configured to generate and to emit the coherent light beam, and a second mode in which the at least one clocked light source is configured to generate the plurality of coherent light beams and to emit the same in the predetermined pattern, wherein the at least one clocked light source comprises a toggle unit configured to switch between the first and the second mode.

8. The device according to claim 4, further characterized by:
a control unit configured to actuate at least one actuator of the gun for correcting the alignment of the gun in the azimuth and/or elevation as a function of the particular correction value.

9. The device according to claim 8,
characterized in that
the control unit is implemented as a fire control computer, wherein the fire control computer is configured to actuate the gun such that the gun fires a projectile or a plurality of projectiles.

10. The device according to claim 9,
characterized in that
the at least one neuromorphic camera is further configured to track a flight path of the projectile fired by the gun for obtaining current calibration data, wherein the computing unit is configured to update the at least one specific base calibration value at least as a function of the current calibration data.

11. The device according to claim 9,
characterized in that
the at least one neuromorphic camera is further configured to track a corresponding flight path of a corresponding projectile fired by the gun from the plurality of projectiles fired by the gun for obtaining corresponding current calibration data,
wherein the computing unit is configured to update the at least one specific base calibration value as a function of the corresponding calibration data obtained after each projectile fired by the gun.

12. The device according to claim 4,
characterized in that
the at least one specific base calibration value comprises at least one reference position indicative of a particular reference angular position of the muzzle of the barrel of the gun, and that the provided detection data comprise at least one particular entry position in the neuromorphic camera of the light beam received by the at least one neuromorphic camera, wherein the particular entry position is indicative of a particular angular position of the muzzle of the barrel of the gun, wherein the computing unit is configured to determine the correction valve by applying a mathematical operation to the at least one reference position and the particular entry position.

13. The device according to claim 1,
characterized in that
the at least one neuromorphic camera comprises an optical aperture and a detector matrix implemented in an optical path of the neuromorphic camera, wherein the at least one neuromorphic camera is configured to receive the at least one emitted light beam through the optical path onto the detector matrix, wherein the optical aperture comprises an aspherical lens implemented, for example, as a metalens or by means of a plurality of DOE (Digital Optical Elements).

14. The device according to claim 4, further characterized by:
a mirror disposed at the muzzle of the barrel of the gun, wherein the at least one clocked light source is configured to emit the generated coherent light beam in the direction of the mirror and the at least one neuromorphic camera is configured to receive at least the light beam reflected by the mirror and is further configured to provide detection data at least from the received reflected light beam.

15. The device according to claim 14,
characterized in that
the at least one specific base calibration value comprises at least one reference position indicative of a particular reference angular position of the muzzle of the barrel of the gun, and that the provided detection data comprise at least one particular entry position in the neuromorphic camera of the light beam reflected by the mirror and received by the at least one neuromorphic camera, wherein the particular entry position is indicative of a particular angular position of the muzzle of the barrel of the gun, wherein the computing unit is configured to determine the correction valve by applying a mathematical operation to the at least one reference position and the particular entry position.

16. The device according to claim 14,
characterized in that
the at least one clocked light source and the at least one neuromorphic camera are each disposed at one end of the barrel of the gun opposite the muzzle of the barrel of the gun.

17. The device according to claim 14,
characterized in that
the at least one neuromorphic camera comprises an optical aperture and a detector matrix implemented in an optical path of the neuromorphic camera, wherein the at least one neuromorphic camera is configured to receive the at least one light beam reflected by the mirror through the optical path onto the detector matrix, wherein the optical aperture comprises an aspherical lens implemented, for example, as a metalens or by means of a plurality of DOE (Digital Optical Elements).

18. The device according to claim 1, further characterized by:
a plurality of neuromorphic cameras, wherein each neuromorphic camera of the plurality is configured to receive at least the emitted light beam.

19. A vehicle, for example a military or a civilian vehicle, having a device according to claim 1.

20. The vehicle according to claim 19,
characterized in that
the vehicle is implemented as an unarmored vehicle, as an armored vehicle, for example as a tracked vehicle such as a battle tank or a wheeled tank, as a watercraft, for example as a warship, and/or as an amphibious vehicle.

21. A method for determining an angular deviation between a line of sight and a line of fire of a gun, comprising the steps of:
a) generating at least one coherent light beam by means of a clocked light source and emitting the at least one generated coherent light beam,
b) receiving at least the at least one emitted coherent light beam by means of at least one neuromorphic camera and providing detection data at least from the received light beam, and
c) determining the angular deviation by means of a correction value indicative of the angular deviation, wherein the correction value is determined as a function of at least one specific base calibration value and the provided detection data.

22. A computer program product comprising commands causing a computer to perform the method according to claim 21 when the program is executed by said computer.
